(19) United States
(12) Patent Application Publication
(10) Pub. No.: US 2019/0221801 A1
(43) Pub. Date: Jul. 18, 2019

(54) BATTERY RETENTION SYSTEM AND METHOD

(71) Applicant: TRAXXAS LP, McKinney, TX (US)

(72) Inventors: Adam Cole Ewing, McKinney, TX (US); Otto Karl Allmendinger, Rowlett, TX (US)

(73) Assignee: TRAXXAS LP, McKinney, TX (US)

(21) Appl. No.: 16/250,867

(22) Filed: Jan. 17, 2019

Related U.S. Application Data
(60) Provisional application No. 62/618,480, filed on Jan. 17, 2018.

(51) Int. Cl. H01M 2/10; A63H 29/22; A63H 17/26; A63H 30/04

(52) U.S. Cl. CPC H01M 2/1083; A63H 29/22; H01M 2220/20; A63H 30/04; A63H 17/262

(57) ABSTRACT

A battery retention system is provided including a first retention system. The first retention system includes a first battery door having a first sliding coupling in a direction between the first battery door and a battery compartment. Also including a first locking mechanism configured to secure the first battery door in a position relative to the the battery compartment. A second retention system including a second battery door having a second sliding coupling in another direction between the second battery door and the battery compartment. Where a second locking mechanism is provided that secures the second battery door in a position relative to the battery compartment and where the second battery door slidably locking in place restricts the opening of the first battery door.

### RELATED APPLICATIONS

This application claims the benefit of a related U.S. Provisional Application Ser. No. 62/618,480, filed Jan. 17, 2018, entitled “BATTERY RETENTION SYSTEM AND METHOD,” to Adam Cole EWING et al., the disclosure of which is incorporated by reference herein in its entirety.

### BACKGROUND

The following descriptions and examples are not admitted to be prior art by virtue of their inclusion in this section.

Model Vehicles controlled through a radio link, such as Radio Controlled (R/C) Cars, Planes, Trucks, and Boats, among others, have increasingly been switching to battery power in place of combustion engines in order to provide propulsion. However, relative to the rest of the model vehicle, the batteries are a significant portion of the entire mass. As model vehicles are competitively raced and face an increasingly harsh and impact laden operating environment, attention has been focused on battery retention in addition to ease of battery replacement.

Currently, R/C Model vehicles typically use a single battery retention system specifically designed to hold the battery in place during model vehicle operation. The types of retention systems vary significantly but one common factor is they only have a single primary system. Failure of the single primary system allows loss of retention of the batteries.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

An embodiment of the claimed disclosure may comprise a battery retention system including a first retention system. The first retention system may include a first battery door having a first sliding coupling in a first direction between the first battery door and a battery compartment and a first locking mechanism configured to releasably secure the first battery door in a position relative to the battery compartment. The battery retention system may further include a second retention system comprising a second battery door. The second battery door may comprise a second sliding coupling in a second direction between the second battery door and the battery compartment and a second locking mechanism configured to releasably secure the second battery door in a position relative to the battery compartment. Wherein the second battery door slidably locking in place inhibits the opening of the first battery door.

Another embodiment of the claimed disclosure may comprise a method for retaining batteries in a model vehicle comprising sliding a first battery door in a first direction from an open position allowing access to a battery compartment to a closed position configured to retain batteries in the battery compartment and locking the first battery door in place with a releasable first locking mechanism. The method further includes slidably coupling a second battery door in a second direction to the battery compartment to secure the first battery door and locking the second battery door in place with a releasable second locking mechanism.

Other or alternative features will become apparent from the following description, from the drawings, and from the claims.

### BRIEF DESCRIPTION OF THE DRAWINGS

Certain embodiments will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIG. 1 is an elevated view of a bottom of a model vehicle, according to an embodiment of the present disclosure;

FIG. 2 is a series of side views of a locking mechanism including an open battery latch, a closed battery latch, and a cross-sectional view showing a closed battery latch, in accordance with an embodiment of the disclosure;

FIG. 3 is an elevated view of FIG. 1 with a first battery door removed, according to an embodiment of the present disclosure;

FIG. 4 is a perspective view of FIG. 3 showing the second latching mechanisms, according to an embodiment of the present disclosure; and

FIG. 5 is a perspective view of FIG. 4 showing the second battery door in an open position, according to an embodiment of the present disclosure.

### DETAILED DESCRIPTION

Reference throughout the specification to “one embodiment,” “an embodiment,” “some embodiments,” “one aspect,” “an aspect,” or “some aspects” means that a particular feature, structure, method, or characteristic described in connection with the embodiment or aspect is included in at least one embodiment of the present disclosure. Thus, the appearance of the phrases “in one embodiment” or “in an embodiment” or “in some embodiments” in various places throughout the specification are not necessarily all referring to the same embodiment. Furthermore, the particular features, structures, methods, or characteristics may be combined in any suitable manner in one or more embodiments. The words “including” and “having” shall have the same meaning as the word “comprising.”

Moreover, inventive aspects lie in less than all features of a single disclosed embodiment. Thus, the claims following the Detailed Description are hereby expressly incorporated into this Detailed Description, with each claim standing on its own as a separate embodiment.

Embodiments of the current disclosure may not require tools to provide access to the battery compartment and batteries. Also, the battery retention system is intended to be very robust to keep the batteries in place during model vehicle operation. One embodiment of this disclosure allows access through the bottom of the model vehicle and does not require tools to gain and secure access. The embodiment may also have a two part retention system that is integrated together to ensure durability during operation.

An embodiment of the battery retention system is accessible through the bottom of the model vehicle. The model vehicle may be turned upside down (on its roof) to have access to the battery system.

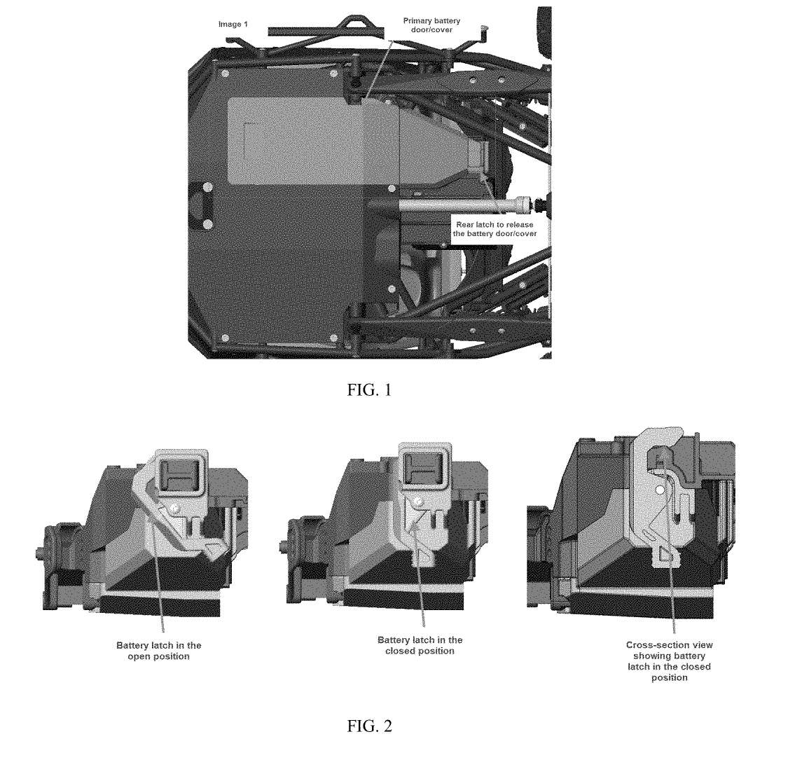

An embodiment of the battery retention system may use a outer battery door that secures the entire battery compartment. The outer battery door may include a latch that locks into position. When in the locked position the latch is not “loaded” with forces in a direction that would allow it to come un-latched. See FIGS. 1 and 2 below. The first battery door may be latched in a horizontal direction while the batteries may provide a loading on the first battery door in model vehicle operation in a vertical direction. In this embodiment, a rotating locking mechanism is used to secure the outer battery door in place.

Elements of the embodiments have been introduced with either the articles “a” or “an.” The articles are intended to mean that there are one or more of the elements. The terms “including” and “having” are intended to be inclusive such that there may be additional elements other than the elements listed. The term “or” when used with a list of at least two elements is intended to mean any element or combination of elements.

Although only a few example embodiments have been described in detail above, those skilled in the art will readily appreciate that a wide range of variations, modifications, changes, and substitutions are contemplated in the foregoing disclosure and, in some instances, some features of the present disclosure may be employed without a corresponding use of the other features.

Embodiments of the current disclosure may not require tools to provide access to the battery compartment and batteries. Also, the battery retention system is intended to be very robust to keep the batteries in place during model vehicle operation. One embodiment of this disclosure allows access through the bottom of the model vehicle and does not require tools to gain and secure access. The embodiment may also have a two part retention system that is integrated together to ensure durability during operation.

An embodiment of the battery retention system is accessible through the bottom of the model vehicle. The model vehicle may be turned upside down (on its roof) to have access to the battery system.

An embodiment of the battery retention system may use a outer battery door that secures the entire battery compartment. The outer battery door may include a latch that locks into position. When in the locked position the latch is not “loaded” with forces in a direction that would allow it to come un-latched. See FIGS. 1 and 2 below. The first battery door may be latched in a horizontal direction while the batteries may provide a loading on the first battery door in model vehicle operation in a vertical direction. In this embodiment, a rotating locking mechanism is used to secure the outer battery door in place.

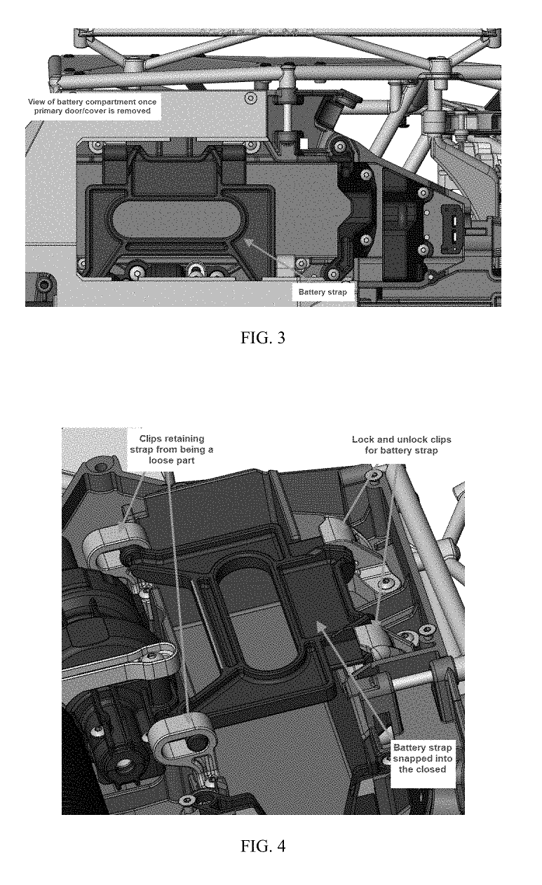

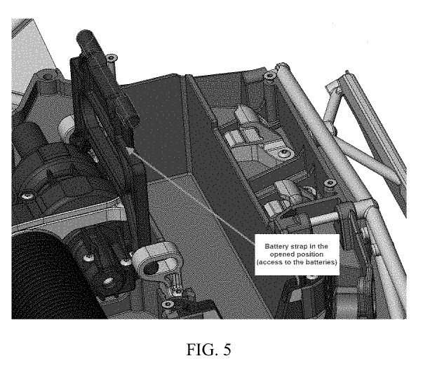

Once the outer battery door is removed it allows access to the inner battery retention system. This inner battery retention system uses a retained (not loose) battery door that can be snapped into the closed position. The inner battery door can then also be un-snapped into the open position for the batteries to be removed when desired. See FIGS. 3, 4 and 5.

One aspect of some of the embodiments of this disclosure is that the battery retention system is a redundant system configured to ensure that the batteries are retained during model vehicle driving/operation. If the primary door/cover comes off during model vehicle operation, the secondary battery retention system with the inner battery door and latch system are still able to function to keep the battery in place.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A battery retention system comprising:
a first retention system comprising:
a first battery door including:
a first sliding coupling in a first direction between the first battery door and a battery compartment;
a first locking mechanism configured to releasably secure the first battery door in a position relative to the battery compartment;
a second retention system comprising:
a second battery door including:
a second sliding coupling in a second direction between the second battery door and the battery compartment;
a second locking mechanism configured to releasably secure the second battery door in a position relative to the battery compartment; and
wherein the second battery door slidably locking in place inhibits the opening of the first battery door.

2. The battery retention system wherein the first direction is substantially perpendicular to the second direction.

3. The battery retention system wherein the first sliding coupling is also configured as a pivoting coupling.

4. The battery retention system wherein the first locking mechanism is a snap fit locking mechanism.

5. The battery retention system wherein the second locking mechanism is a rotating locking mechanism.

6. The battery retention system wherein first battery door pivots to provide access to the battery compartment.

7. The battery retention system wherein the first battery door is movably secured to the battery compartment.

8. A method for retaining batteries in a model vehicle comprising:
sliding a first battery door in a first direction from an open position allowing access to a battery compartment to a closed position configured to retain batteries in the battery compartment;
locking the first battery door in place with a releasable first locking mechanism;
slidably coupling a second battery door in a second direction to the battery compartment to secure the first battery door;
locking the second battery door in place with a releasable second locking mechanism.
